(19) United States
(12) Patent Application Publication
(10) Pub. No.: US 2016/0148309 A1
(43) Pub. Date: May 26, 2016

(54) Systems and Methods for Onsite or Remote Dispensing of Credit Instruments

(71) Applicant: THINK CARDS INTELLECTUAL PROPERTY CORP., Toronto (CA)

(72) Inventors: Tony Canapini, Whitby (CA); Brian A. Steinhauser, Caledon (CA)

(21) Appl. No.: 14/787,949

(22) PCT Filed: Apr. 28, 2014
(86) PCT No.: PCT/CA2014/050401

§ 371 Date: Oct. 29, 2015

Related U.S. Application Data
(60) Provisional application No. 61/816,983, filed on Apr. 29, 2013.

(51) Int. Cl. G06Q 40/02

(52) U.S. Cl. CPC G06Q 40/025

(57) ABSTRACT

Systems and methods for instantly granting, issuing and dispensing a credit instrument to an applicant, by a credit instrument issuer, responsive to a credit instrument application, comprising creating a credit instrument application, on behalf of an applicant, using an application creation computing device, sending the credit instrument application to a data collection server, verifying the applicant Vs identity and obtaining a credit instrument application decision, and if the credit instrument application decision is a decline notifying the applicant, otherwise notifying the applicant and dispensing a credit instrument including the credit instrument parameters.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Typically, consumers apply for credit instruments by filling out a paper form, or visiting a website, and providing information to complete an application. Occasionally such applications may involve fixing the application or providing further information. Sometime after the application is completed (typically on the order of a week or ten days), the consumer applicant will receive the decision about whether they are being offered the credit instrument. Often this decision will come in the form of receiving the credit instrument itself. At that point, the credit instrument typically needs to be activated—as too many opportunities for fraud exist between application and issuance. Shortly after activating the credit instrument the consumer may begin using the credit instrument.

This approach introduces several problems, including a cumbersome application process, significant opportunities for increased handling of incomplete or atypical applications, uncertainty about the actual identity of the applicant, the length of time between 1) application and receipt of the credit instrument and 2) receipt of the credit instrument and the ability to enter transactions using the credit instrument.

Additionally, mobile technology is evolving and credit instrument capabilities are being installed into smart phones and tablets, in the form of “e-wallet” solutions that can store multiple loyalty or credit cards in one device. However there is no known method of instantly activating this credit instrument capability while the consumer is at an onsite or remote location.

Some systems have been developed to attempt to address the delay between application and receipt of the credit instrument, allowing remote printing of credit cards.

However, such systems do not address all of the above problems, and there thus remains a need for improved systems and methods for remote dispensing of credit instruments.

### SUMMARY OF THE INVENTION

In one aspect the invention provides a method for dispensing a credit instrument to an applicant at an onsite or remote location, by a credit instrument issuer, responsive to a credit instrument application, the method comprising:

creating a credit instrument application using an application creation computing device to electronically obtain application data from an applicant;
sending the credit instrument application to a data collection server;
receiving from the data collection server, a credit instrument application decision from a credit decisioner;
if the credit instrument application decision is an approve:

receiving one or more credit instrument parameters from a credit instrument issuer;

dispensing a credit instrument for the applicant with the credit instrument parameters.

In another aspect the invention provides a method for submitting a credit instrument application on behalf of an applicant via an application creation computing device, the credit instrument application comprising a set of required credit instrument application fields, the method comprising:

scanning an identification provided by the applicant;
populating one or more required credit instrument application fields of the set of required credit instrument application fields;
confirming the applicant's identity; and
if confirmed:

submitting the credit instrument application.

In another aspect the invention provides a system for dispensing a credit instrument to an applicant at an onsite or remote location, by a credit instrument issuer, responsive to a credit instrument application, the system comprising:

an application creation computing device, configured to:
electronically obtain application data from an applicant;
create a credit instrument application on behalf of an applicant;
send the credit instrument application to a data collection server; and
receive a credit instrument application decision;
a data collection server, configured to:
receive the credit instrument application;
obtain a credit instrument application decision from a credit decisioner;
notifying the application creation computing device of the credit instrument application decision;
if the credit instrument application decision is an approve:

receiving one or more credit instrument parameters from a credit instrument issuer; and

providing the credit instrument parameters to a credit instrument dispenser; and

a credit instrument dispenser configured to:
receive one or more credit instrument parameters from the data collection server; and
dispense a credit instrument for an applicant including the credit instrument parameters.

In another aspect the invention provides a computer-readable medium containing instructions corresponding to a method for dispensing a credit instrument to an applicant at an onsite or remote location, by a credit instrument issuer, responsive to a credit instrument application, the method comprising:

creating a credit instrument application, on behalf of an applicant, using an application creation computing device to electronically obtain application data from an applicant;
sending the credit instrument application to a data collection server;
receiving from the data collection server, a credit instrument application decision from a credit decisioner;
if the credit instrument application decision is an approve:

receiving one or more credit instrument parameters from a credit instrument issuer;

dispensing a credit instrument for the applicant with the credit instrument parameters.

In another aspect the invention provides a method for dispensing a credit instrument to an applicant at an onsite or remote location, by a credit instrument issuer, responsive to a credit instrument application, the method comprising:
receiving a credit instrument application;
obtaining by the data collection server, a credit instrument application decision from a credit decisioner;
if the credit instrument application decision is an approve:
   receiving one or more credit instrument parameters from a credit instrument issuer;
   causing the dispensing of a credit instrument for the applicant with the credit instrument parameters.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for remote or on-site dispensing of credit instruments according to a non-limiting embodiment of the present invention;

FIG. 2 is a flowchart depicting a method for remote dispensing of credit instruments according to a non-limiting embodiment of the present invention;

FIG. 3 is a flowchart depicting a method for creating an application for remote dispensing of credit instruments according to a non-limiting embodiment of the present invention;

FIG. 4 is a flowchart depicting a method for authenticated communication between an application computing device and a data collection server, for remote dispensing of credit instruments, according to a non-limiting embodiment of the present invention;

FIG. 5 is a flowchart depicting a method for remote dispensing of credit instruments, according to a non-limiting embodiment of the present invention.

### DETAILED DESCRIPTION OF THE INVENTION

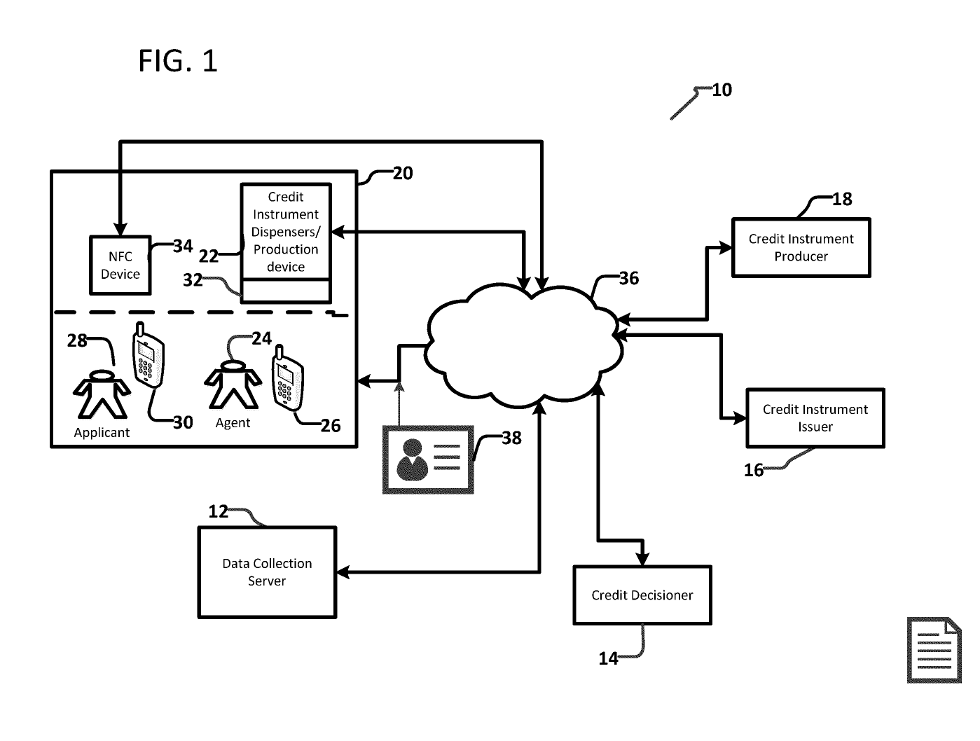

FIG. 1 is a diagram of a system 10 for remote or onsite dispensing of credit instruments according to a non-limiting embodiment of the present invention comprising credit instrument issuer 12, credit decisioner 14 who may also perform an identity confirmation pursuant to current credit card regulatory requirements, data collection server 16, credit instrument producer 18, one or more credit instrument dispensing locations 20 further comprising credit instrument dispenser 22 which may further comprise credit instrument 32, consumer/applicant 28 who may have applicant computing device 30, agent 24 who may have application creation computing device 26, NFC device 34, communication network 36 and credit instrument application 38 (or application 38).

System 10 operates to allow remote or onsite and real-time (or near real-time) applications for, approval for, and dispensing of, credit instruments 32, as described herein. As used herein, remote means away from credit instrument issuer's back office or location where normal work flows occur that result in credit instruments being, for example, mailed to applicant. As used herein, onsite means at a location not associated with back office functions and may include locations of one of the entities described herein, such as at a retail location. System 10, via one or more entities such as data collection server 12, may maintain auditable trails of all transactions (applications, credit and other checks, approval and denial decisions and communications, issuance/dispensing of credit instruments 32, marketing opt ins received, promotional offers used, transactions finished or occurring with the recently dispensed credit instrument, and the like). This may be accomplished, for example by assigning unique identifiers to each step that is performed, and the result of such step.

Credit instrument issuer 12 may be any company or entity, or combination thereof, which offer credit instruments. By way of example, credit instrument issuer 12 may be a credit card company, such as American Express, a bank offering industry branded credit cards such as MasterCard™ or VISA™, a retail or other company that offers a privately labeled credit card, such as Walmart™ Credit Card or a combination of such entities that together offer credit instruments 32. Credit instrument issuer 12 may have many different systems, including computer systems (including processors, databases, programming instructions stored in memory, networking technology, wireless networks, Chip and PIN card production equipment and the like), to perform the functionality described herein. Credit instrument issuer 12 may, for example, be part of making a credit decision for an application, storing and analyse data relating to the applicant and transactions relating to one or more credit instruments, and providing data relating to the credit instrument to be issued (“credit instrument data”).

Credit decisioner 14 may be any company or entity, or combination thereof, which is involved in rendering one or more of a credit check and fraud check on an applicant. Credit decisioner 14 may be, for example, a third party credit bureau that credit instrument issuer 12 procures credit and fraud checking services from credit bureaus (such as Equifax, Trans Union or Experian). Alternatively credit instrument issuer 12 may perform their own credit or fraud check, or may work in combination with a third party credit bureau that provides a credit granting system as part of their offerings.

Data collection server 16, may be a central component of system 10, performing functions as described herein. Exemplary functions that may be performed by data collection server 16 include:
(a) Authenticating agent computing devices, and the user (such as an agent) operating such agent computing devices (for example via agent codes being sent to, and confirmed by, data collection server), prior to receiving credit instrument applications therefrom;
(b) Receiving credit instrument applications from agent computing devices;
(c) Providing the required information to one or more of:
   (i) credit instrument issuer 12, such as receiving parameters of the eventual credit instrument 32,
   (ii) credit decisioner 14, such as applicant information required to make a credit decision,
   (iii) credit instrument producer, such as the indication to produce credit instrument 32 and parameters therefor;
(d) Communicating with applicant 28, for example to provide application or marketing materials, the ability to apply or opt into marketing programs, agreements relating to the credit instrument 32, or materials to allow credit instrument 32 to be obtained or prepared.

Credit instrument producer 18 may be any company or entity, or combination thereof, which may be responsible for the systems that produce the credit instruments (such as printers, download sites for NFC, and the like). An exemplary credit instrument producer 18 is Gemalto Inc. or Giesecke and Devrient GMBH that already produces credit cards for card issuers for their existing mail based fulfillment process. Credit instrument producer 18 may perform functions as described herein, such functions may include:
(a) Receiving application information from data collection server 16;
(b) Coordinating the obtaining of a credit decision with credit decisioner 14 and credit instrument issuer 12;
(c) Owning or controlling one or more credit instrument dispensers 22 and communicating with such credit instrument dispensers 22 to allow credit instruments 32 to be created and dispensed;
(d) Sending applicant 28 a communication (such as a link) by email or in a text message to download credit card credentials and capabilities to their NFC (near field communications) enabled mobile device or e-wallet to permit purchase transactions between their device and NFC enabled point of sale terminal
(e) Storing and maintaining credit instrument 32 information for purposes of producing and activating credit instruments 32 on behalf of the credit instrument issuer in accordance with regulatory and security standards as required for credit card issuers
(f) Updating the credit instrument issuer's 12 legacy systems and customer databases with new credit card applicant information

Remote dispensing location 20 may be the location where credit instrument 12 is dispensed. Remote dispensing location 20 may be at a retailer, event space, bank, or other company, for example that may want to dispense a credit instrument onsite. Remote dispensing location 20 may be a location of credit instrument issuer 12, for example.

Credit instrument dispenser 22 is any device that can actually dispense credit instrument 32.

In one embodiment of the present invention credit instrument dispenser 22 is a printer that can create and dispense credit cards. It may receive parameters with which to “print” the credit card (a number, expiry and the like) and may have “blank” credit cards (having some credit card information but not all that may be required to dispense the card). It may also have functionality, similar to ATMs, that allow applicants to re-insert the credit card and specify their PIN so that they applicant can immediately use the credit card.

Credit instrument 32 may be a credit card, debit card, pre-paid card, loyalty card, near-field communication (NFC) application, or the like. Essentially credit instrument 32 may be anything that allows purchasing of goods or services on credit.

NFC enabled device 34 such as a smart phone, tablet, or any other instrument capable of conducting a credit cards transaction by being in close proximity (within inches) of a similarly enabled point of sale terminal may be a particular example of credit instrument 32, and may be substantially as known to those of skill in the art. It is to be understood that although NFC is described herein, other similar protocols or products may be used instead of NFC. It is also to be understood that applicant computing device 30 may be, or may become, an NRF enabled device 34. NFC enabled device 34 may be, be part of, or comprise an e-wallet.

Application creation computing device 26 may be substantially any computing device that is configured to perform the functionality described herein, such as allowing an application to be created. Application creation computing device 26 may be configured to communicate with, and authenticate with, data collection server 12, for example to ensure fraud does not occur in system 10.

Application creation computing device 26 may be a mobile computing device (such as a smart phone, tablet or the like), point of sale (POS) device or kiosk. Examples of application creation computing device 26 and application creation include:
(a) a smart phone being used by an agent that scans identification to have an application created;
(b) a cash register used by a cashier that is enabled for scanning or application creation;
(c) a smart phone activation terminal that receives applicant information to activate a smartphone, and may also be used to create an application.
(d) a handheld scanning device capable of capturing data from 3d bar codes, QR codes, RFD (radio frequency indentification) tags and the like.
(e) A digital camera or picture phone capable of attaching text to an image and transmitting both the text and the image to a data collection server along with the applicant data.

Communication network 36 may be any one or more communication networks, which may work together or independently, to facilitate communication of the various aspects of system 10. Any and all of credit instrument issuer 12, credit decisioner 14, data collection server 16, credit instrument producer 18, credit instrument dispenser 22, consumer computing device 30 and application creation computing device 26 may be able to communicate with each other via one or more of their systems, as described herein, and via one or more portions of communication network 36. Communication network 36 may include cellular, WiFi, Bluetooth, wired, wireless, private, public, or any form of network or network technology.

Application 38 may be any application for credit instrument 32 and may preferably be in electronic form so as to enable it being communicated over communication network 36. Application 38 may have one or more application fields of various types (text, numerical, picture, biometric, and the like), some of which may be required (for example name, address, birth date) while some may be optional (for example work phone number, email, apartment number). An application may thus be said to have one or more data sets and may be organized as a data structure, for example that may be communicated initially from application creation computing device 26 to data collection server 12, as described herein.

It is to be understood that various entities are described herein and are described as performing some part, or parts, of methods herein. However, the particular entity that performs the particular part, or parts, of methods may be changed, combined or re-configured to suit the business agreement, meet the laws and regulations of the jurisdiction in which the credit instrument is being issued, industry technologies, communications, security standards, competencies, etc, of the particular implementation of aspects of the invention described herein.

In particular, it is to be understood that:
(a) data collection server 16 and credit instrument producer 18 may perform some or all of the functionality ascribed to either herein, as may be required by;
(b) identity verification software may be installed or operated on one or more of application creation computing device 26, data collection server 16 or consumer computing device 30;
(c) Credit decisions may be received from a credit decisioner 14, or from the credit instrument issuer 12, or from credit instrument producer 18.
(d) Fraud and identity checks can be performed by the credit decisioner 14, or by the credit instrument issuer 12 or other third parties (not shown) enabled to do so.

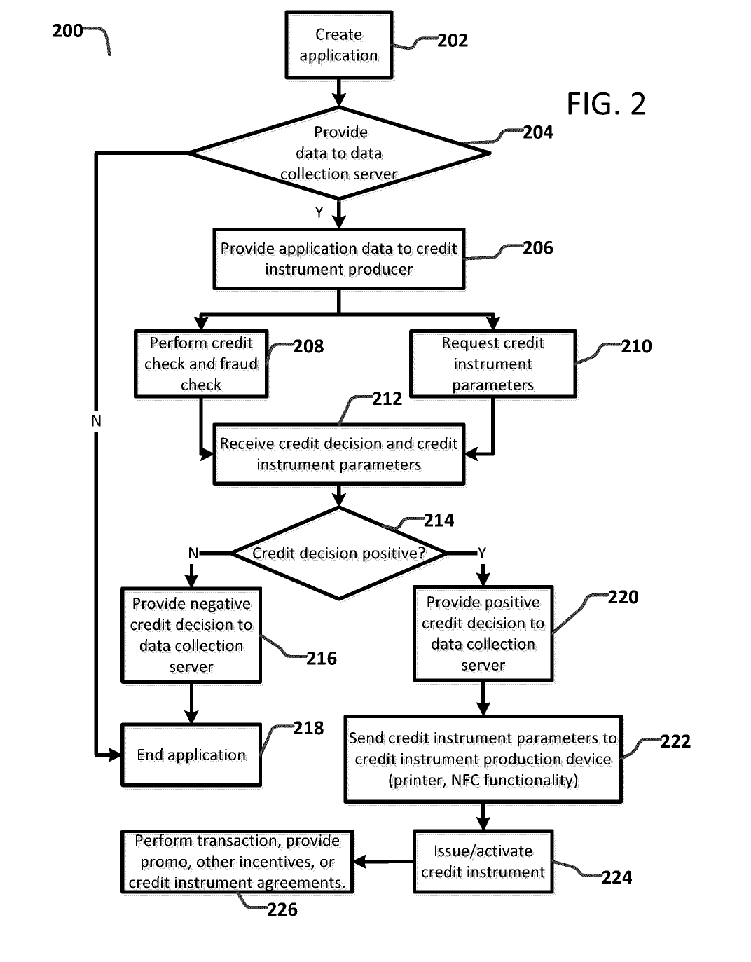

FIG. 2 is a flowchart depicting a method 200 for remote dispensing of credit instruments according to a non-limiting embodiment of the present invention.

Before discussing method 200, various outcomes of method 200 (and related methods 300 and 400), are presented in the below Table 1. In summary, and as will be discussed herein, applicant 28 may be applying for credit instrument 32, with multiple possible outcomes. They may also be “applying”, or opting in, to receive marketing materials or promotional offers. Numerous factors about applicant 28 and application 38 may lead to the outcomes below. Presenting the outcomes in Table 1 will then set the stage for the discussion of when and why those outcomes may arise.

TABLE 1
Credit Instrument Application Outcomes

| | | |
|---|---|---|
| G1 | Credit approved, credit | Completed transaction, (dispensing and |
| | instrument created, activated, | activation of the credit instrument) the |
| | and charged for Promotional | applicant uses credit instrument right |
| | items | away. |
| G2 | Credit approved, credit | Completed transaction (dispensing and |
| | instrument created, activated, | activation of credit instrument), the |
| | promotional item not charged | applicant does not use the credit |
| | to card | instrument right away. |
| G3 | Credit approved, credit | This may be a hardware malfunction or the |
| | instrument created but not | consumer changes their mind and does not |
| | activated | accept the credit instrument. |
| CB4 | Credit decision delivered, not | Credit instrument not approved by client, |
| | approved, credit instrument | credit instrument not activated by card |
| | not created | producer. |
| CB5 | Credit decision not delivered, | Card Issuer will not issue credit instrument |
| | AML fraud check passed, | without a credit decision. This can occur if |
| | credit instrument not created | there is insufficient data at the credit |
| | | bureau, sometimes called a “thin file” with |
| | | only a name only and few or no trade |
| | | lines, or the file is being disputed. |
| CB6 | Credit decision not delivered, | Issuer won't provide a credit instrument if |
| | AML fraud check failed, credit | AML anti money laundering fraud test |
| | instrument not created | fails causing risk the applicant is a |
| | | potential criminal. |
| DC7 | Valid applicant identity is | No hit means the credit decisioner does not |
| | captured (credit instrument | have the applicant/consumer's information |
| | application created), sent to | in their credit database. This happens |
| | credit decisioner, no hit occurs | occasionally if the consumer does not have |
| | | credit relationships, they are from another |
| | | country and have not established domestic |
| | | credit relationships yet, or the applicant is |
| | | under the age of majority to have credit |
| | | relationships. |
| DC8 | Valid identity captured (credit | Opt in means applicant/consumer agrees to |
| | instrument application not | receive marketing solicitations but they |
| | created), marketing opt-in | don't want a credit instrument or don't |
| | (consumer's contact | wish to apply for a credit instrument, or |
| | information) is sent directly to | they are under the age of majority to apply |
| | card issuer bypassing the credit | for a credit instrument.. |
| | decisioner | |

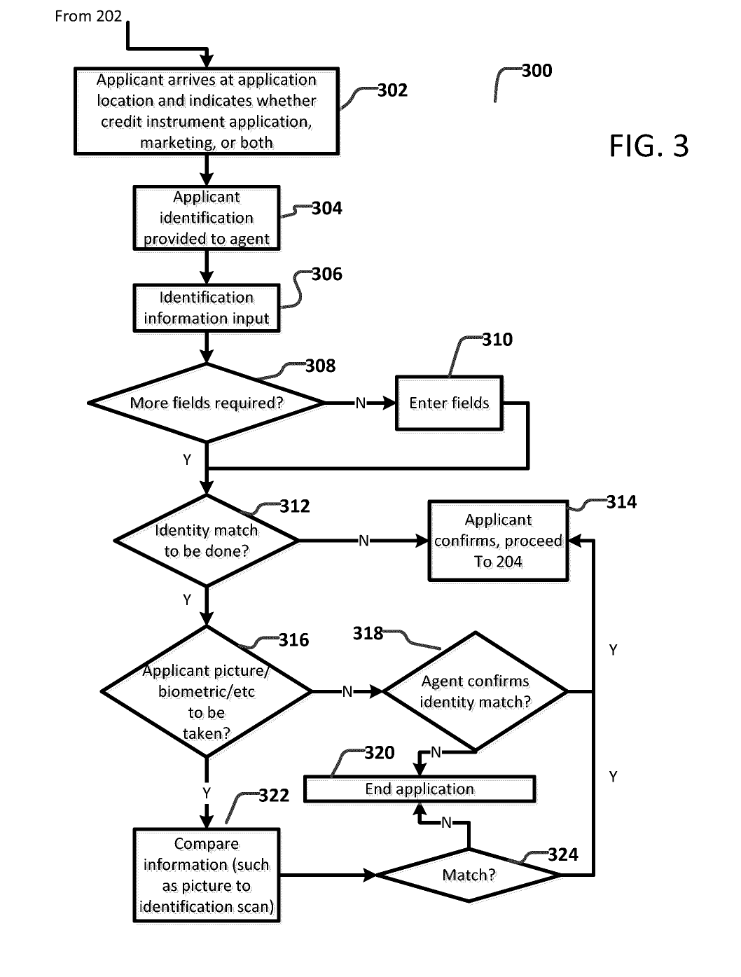

Continuing with method 200, such method begins at 202 where an application for credit instrument 32 is created. Application creation may be performed by entities or systems as described herein. Application creation may occur as described herein, for example as described with respect to FIG. 3 and method 300. At a high level, the entirety of the application needs to be created at 202 (ie that data is not missing), the applicant consents to the application (including performing a credit check, and/or subscribing to receive marketing materials), and optionally that the applicant's identity has been confirmed in some manner.

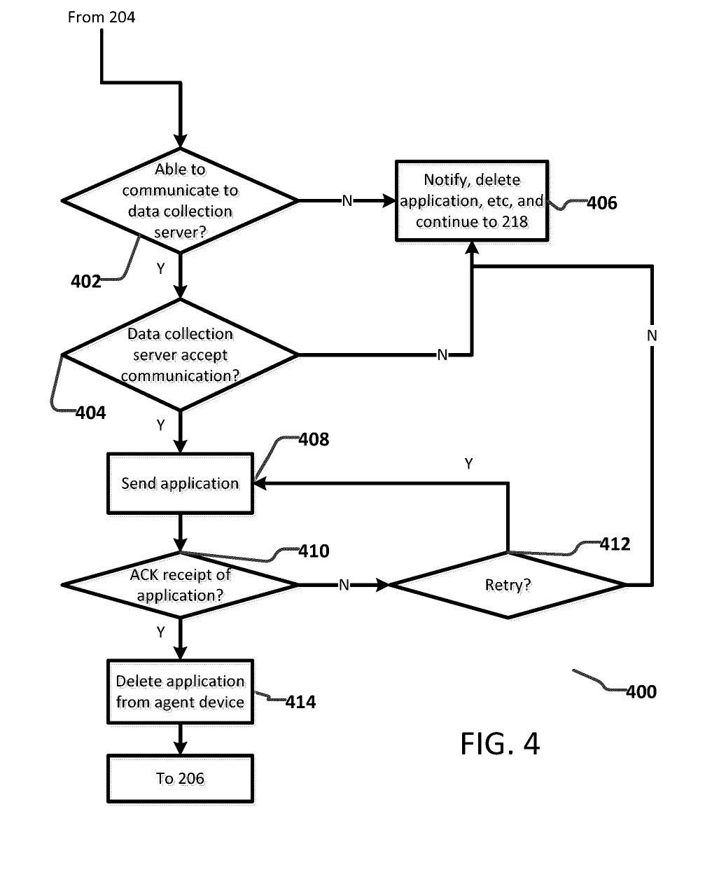

Once an application is created, method 200 continues at 204 to query whether application data is provided to data collection server 12. Providing application data may be performed by entities or systems as described herein and may occur as described herein, for example as described with respect to FIG. 4 and method 400. Application data may be provided electronically. At a high level, the communication must be possible over communication network 36, and application creation computing device 26 (and any user thereof) must be authenticated to avoid fraud.

If application data is not provided, method 200 terminates at 218. Termination may involve, for example, deleting the application from application creation computing device 26, and other actions as described herein. In some embodiments, application data not being provided at 204 may be as a result of a potential security, or related, threat. In such situations it may be desirable to, and application creation computing device may be configured to, allow application creation computing device 26 to be disabled and/or for the agent using such application creation computing device 26 to be temporarily prevented from creating applications.

If application data is provided, method 200 continues at 206 where application data is provided to credit instrument producer 18. In one embodiment, credit instrument producer 18 may then perform, or have performed credit and fraud checks (at 208) and request instrument parameters (at 210). These two may be performed in serial or parallel, but may involve communicating with different entities, as described herein. In some embodiments both data collection server 26 and credit instrument producer 18 may be duplicative, such that only one of the two may be required. For example, the entity controlling data collection server 26 may have the required credit instrument production device(s) and may be able to perform substantially all of the functionality of credit instrument producer 18.

Continuing to 208, various checks may be made to determine the suitability of applicant 28 for credit instrument 32. Fraud checks and credit checks may be substantially as known in the art, and may be performed by the same, separate, or multiple parties (such as credit bureaus/credit decisioners 14, credit instrument issuers 16, and the like). Such checks may include or involve reference to third party databases, such as fingerprint or retina scan databases, telephone or address directories, existing customer databases (such as those of credit instrument issuer 16), and the like, any of which may be referred to as identity databases.

At 210, credit instrument parameters may be requested, with such request for example being directed to credit instrument issuer 16. Parameters may include credit instrument numbers (such as a credit card number), an expiry date, credit limit (which may be set in conjunction with other information, for example, the results of the credit and/or anti-fraud check results).

At 212 the results of 208 and 210 are assembled at the credit instrument producer 18 (again bearing in mind that in some embodiments, credit instrument producer 18 may be duplicative and data collection server 12 may be involved instead).

At 214 if the information received at 212 is all positive/affirmative, and the required parameters are received, method 200 may proceed to 220 where such positive result may be provided to data collection server 12. Such result may be substantially similar to one of outcomes G1, G2, or G3 as per Table 1, Credit Instrument Application Outcomes.

This may be done largely so that applicant 28 and/or agent 24 may be notified of the result, at 220. This will allow them to continue to credit instrument production device 22 to receive credit instrument 32.

Also, at 222, credit instrument parameters may be sent to credit instrument production device 22 so that credit instrument 32 may be created. This may involve, for example, downloading credit card parameters into an NFC enabled device to operate within established NFC parameters, as described herein.

Then, at 224, credit instrument 32 is issued (completed and dispensed), such that applicant 28 can either hold it (such as with a credit card) or can install Credit Instrument enabled capabilities on their NFC enabled device 34. Additionally, and as known in the art, authorizing may occur at 224, for example where applicant 28 selects a PIN (Personal Identification Number) for credit instrument 32 (such as by re-inserting it into credit instrument production device 22 for authorization, or by creating a PIN within their NFC enabled device 34). Also at 224, the Credit Instrument Producer 18 may update the Credit Instrument Issuer 16, that a new credit instrument 32 has been activated for the applicant 28. Method 200, at least until 224, may be completed in relatively short time, such as in five minutes. If credit instrument 32 requires downloading or intervention by applicant 28 then additional time may be required.

At 226 the transaction may be completed (such as if application 38 was created as a consumer was attempting to purchase goods), promotional items, other incentives, and the credit instrument agreements are provided. If the applicant is simply consenting to opt into a marketing program, method 200 may proceed from 202/204 directly to 226, with a simplified process for ensuring that the proper information was provided and received to opt into the marketing program. At 226, the consumer/applicant 28 may be added to a customer database that may be at credit instrument issuer 32 (not shown).

Credit instrument agreements may be printed and dispensed when credit instrument 32 is dispensed, emailed or otherwise communicated (for example electronically) to the applicant. Such provision of credit instrument agreements may be tracked so that a audit record exists, for example that can be relied on by credit instrument issuer 16.

At 214 if any of the information received at 212 is all negative method 200 may continue at 216 where the negative decision is provided to data collection server 12 to be further communicated to applicant 28 and/or agent 24 for their notification. Method 200 would then terminate at 218, as described herein. Such result may be substantially similar to one of outcomes CB4, CB5, CB6, or DC7 as per Table 1, Credit Instrument Application Outcomes.

FIG. 3 is a flowchart depicting a method 300 for creating an application for remote dispensing of credit instruments according to a non-limiting embodiment of the present invention.

Method 300 begins at 302, from method 200 at 202, where applicant 28 arrives at an application location or anywhere that has an application creation computing device 26 (such as credit instrument dispensing locations 20), which may be substantially as described herein. Applicant may indicate whether they wish to apply for credit instrument 32, join a marketing program, or both. If only a marketing program is being ‘opted into’ then outcome DC8 as per Table 1, Credit Instrument Application Outcomes may occur.

At 304 applicant identification such as a driver's license is provided, for example to agent 24 or otherwise presented to application creation computing device 26 (as described herein, such as when a consumer wants to activate a cell phone or credit instrument, provides the required information, and then becomes an applicant 28 for credit instrument 32).

At 306 the applicant's information is input into an application 38. This may involve invoking the scanning functionality of application creation computing device 26, asking a POS system to use the already-provided information (provided for another purpose—completing a purchase or return, activating a cell phone, and the like), and other approaches as described herein. As a result, one or more application fields may be filled.

In one embodiment, a driver's license or other similar identification document may be scanned by commercially available scanning software, that may be installed and running on application creation computing device 26. Such software may know, or be able to be configured to know, which fields from the driver's license to read (such as via 3d bar codes, QR codes, RFD tags or optical character recognition) and add to application 38.

At 308, a query is made whether all required fields were provided or input. The required fields may vary based on, for example, credit instrument issuer 16 requirements, parameters of credit instrument 32, and the like. In addition, if the applicant is only opting into a marketing program then fewer fields may be required (such as only a name and email address). If further fields are required, method 300 continues at 310 where the other required fields are entered. This may be accomplished, for example, manually by either agent 24 or applicant 28, or by re-attempting 302-306, for example with another piece of identification or application creation computing device 26. Method 300 at 308 may help avoid a problem with application processes lacking any confirmation that the required information has been received, and received correctly (for example is readable).

If all required fields are provided, method 300 continues at 312 to ask whether an identity match is to be done. The identity match may be largely to confirm that the applicant presenting themselves matches the applicant in the identification that was provided as the basis for application 38, or to determine that applicant 28 is worthy of being issued credit instrument 32 (such as credit-worthiness, no history of crime or fraud, and the like). The query at 312 may involve one or more matches or tests, and may be multi-modal—various approaches being used simultaneously. If only a marketing opt in is occurring an identity match, for example from the Credit Decisioner, may not be required, however a confirming email or text message or a letter to the Applicant's physical address may be sent acknowledging the Applicant's consent to opt into a marketing program which is the required industry practice.

If no identity match is to be performed, method 300 continues to 314 and returns to 204 of method 200. At 314 however, applicant's confirmation may be for one or more directions, such as via application creation computing device 26. For example, applicant's confirmation may be to:
(a) Proceed or not in applying for credit instrument 32 as per application 38;
(b) Proceed or not in applying to be provided marketing materials, or some consideration just for having filled out the application, for example via a provided email address (or SMS, mailing, and the like); or
(c) Any possible combination of the above.

It is to be understood that applicant 28 may be encouraged to apply for credit instrument 32 by being offered incentive promotional items, for example where the greatest incentive is for applying for credit instrument 32.

If a match from the credit decisioner is to be performed, method 300 continues to 316 to query whether a picture, biometric scan, or other data is to be collected about applicant 28. If not then method 300 continues to 318 where agent 24 confirms that the picture in the identification provided appears to be the same person as is standing in front of them (a manual confirmation of identity match). Method 300 then continues to 314.

If a picture, scan or other comparison/confirmation is to be performed then at 322 the picture or scan is performed and is compared, for example to the Applicant and sent to the Data Collection Server along with the application information. Such performance and comparison can be done by one or more entities, alone or in combination, such as data collection server 12, credit decisioner 14, or credit instrument issuer 16. Several embodiments of such comparison are possible, including various technologies and entities of system 10, including:
(a) a picture is taken of the applicant presenting themselves, and that picture is compared (by facial recognition software for example) to the picture scanned from the identification;
   (i) where the comparison is performed by application creation computing device 26, data collection server 12 (possibly after application 38 has been finalized and sent to data collection server 12), credit decisioner 14, etc;
(b) a retinal or fingerprint scan is done and such scan is compared to a database of retinal or fingerprint scans that may be maintained by, or accessed by, application creation computing device 26, data collection server 12 (possibly after application 38 has been finalized and sent to data collection server 12), credit decisioner 14, etc;
(c) voice recordings may be digitally captured and compared against voice recognition databases;
(d) signature images may be digitally captured at time of application for subsequent comparison to original signatures already on file or signatures to be reproduced by the applicant.

It is to be appreciated that a picture or scan required at 316 can be used to apply for credit instrument (and/or marketing opt in) but can also then be stored and subsequently used for transaction approval or subsequent dispute resolution or fraud investigation. For example, if a picture is taken when application 38 is created, in a subsequent transaction the seller (such as a retail location) can take a picture of the consumer and have the picture taken at the time of transaction compared to the picture taken at the time of applying for credit instrument 32.

Returning to method 300, if the comparison matches at 324 then method 300 continues to 314. Otherwise in the event of a non matching comparison, method 300 continues to 320 where application 38 is terminated and proceeds to method 200 at 218. At 320, the non-matching occurrence may be captured and sent to the credit instrument issuer to be stored for future applicant comparisons or fraud investigations.

FIG. 4 is a flowchart depicting method 400 for authenticated communication between an application computing device and a data collection server, for remote dispensing of credit instruments, according to a non-limiting embodiment of the present invention.

Method 400 begins at 402, from method 200 at 204, to query whether communication is possible with data collection server 12. This may depend on multiple factors, such as the availability of wireless or landline communication network 36 or whether use of communication network 36 is permitted, whether the handheld device 26 is malfunctioning, the agent ID/Password in invalid, the data collection server is malfunctioning, the data center or cloud that is housing the servers is down, or application creation computing device 26 is known to be stolen or operating from an unauthorized location.

If communication is not possible, method 400 continues to 406 where application 38 (and/or marketing opt in) is deleted, notification is provided (to agent 24, cashier, applicant, or any other person involved in the application process), and method 400 returns to method 200 to terminate at 218.

If communication is possible method 400 continues to 404, to query whether such communication is accepted by data collection server 12. Several factors may be involved, such as:
(a) Whether the originator of the communication (application creation computing device 26, applicant computing device 30, POS, and the like, as described herein) is trusted or authenticated;
(b) Whether agent 24 is trusted or authenticated. An agent 24 may use one or more application creation computing device 26 and each application creation computing device 26 may be used by one or more agents 24. Thus, agents 24 may login manually using their ID and password or otherwise authenticate themselves, for example by an agent's 24 NFC enabled security card, which can “tap” the application creation computing device 26 to log the agent into the system for use;
(c) The communication is at an acceptable time, via an accepted communication network 36;
(d) The communication is suitably encrypted;
(e) The consent boxes indicate the applicant has provided permission for a credit check if an application is requested, or permission to just receive marketing information if the credit check box is not affirmatively populated;
(f) The device is an approved device confirmed to be operating from an authorized location during an authorized time frame.

Method 400, at 404, may prevent occurrences of fraud, such as unauthorized use of application creation computing device 26 or communications that may be intercepted and/or altered.

If the communication is not accepted then method 400 proceeds to 406, substantially described herein. Depending on the reason for not accepting communication, application creation computing device 26 may be locked, disabled or erased (for example if the device is operating from an unauthorized location, or at an unauthorized time, or is reported stolen or fraudulent activities are thought to be occurring).

If the communication is accepted then method 400 proceeds to 408 where application 38 (and/or marketing opt in) is sent. At 410 the device originating application 38 (such as application creation computing device 26) waits for an acknowledgement of receipt of communication. If it is not received, retries (or waiting) may occur at 412. Otherwise, at 414 application 38 may be deleted from application creation computing device 26 and method 400 may return to method 200 at 206.

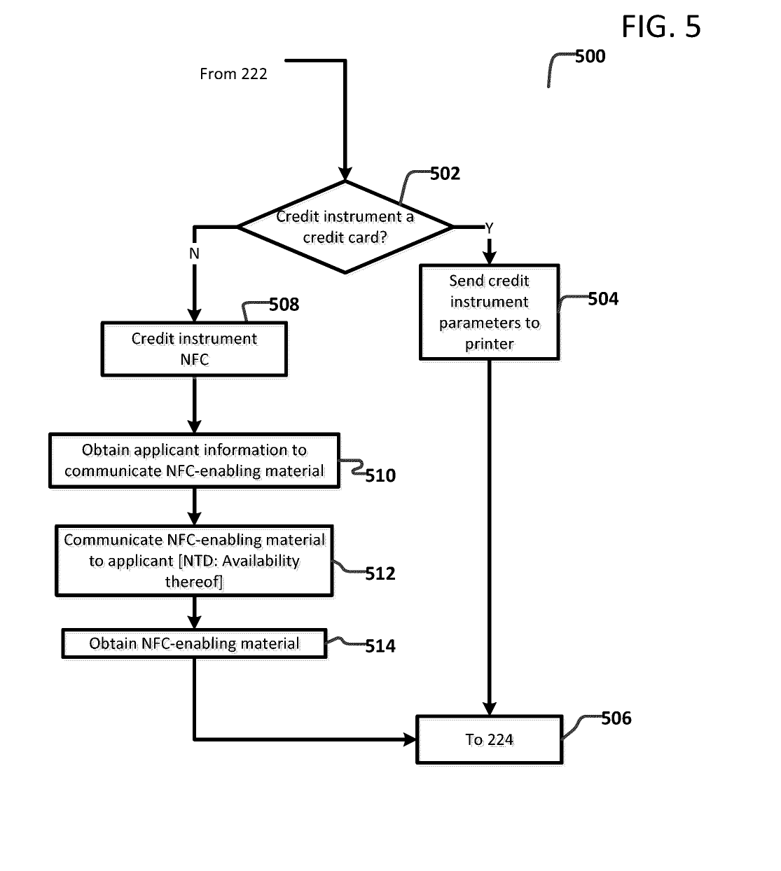

FIG. 5 is a flowchart depicting method 500 for remote dispensing of credit instruments, according to a non-limiting embodiment of the present invention.

Method 500 begins at 502, from method 200 at 222, to query whether credit instrument 32 is a credit card. If so, at 304 credit instrument parameters are sent to credit instrument dispenser 22. Credit instrument parameters may be as described herein and may include a or a secure computer chip enabling a PIN, or a credit card number to be embossed on a blank or preprinted credit card located at credit instrument dispenser 22. Such parameters may be sent from credit instrument issuer 16, credit decisioner 14, or credit instrument producer 18, or a combination thereof. Of course some or all of the parameters may be created by one or more different entities than that which ultimately provides the parameters to credit instrument dispenser 22. In one embodiment, credit instrument producer 18 may have established and secure communication paths to credit instrument dispenser 22 and may thus amalgamate information that is to be sent, and handle the sending. Method 500 may then proceed to 224.

At 502 credit instrument 32 may not be a credit card but may be an NFC device or card, such as at 508. Method 500 then proceeds to create or enable the NFC device.

At 510 information about the applicant is obtained to communicate the—enabling credentials and material to be installed into an NFC enabled device to permit purchase transactions to occur over point of sale devices as if the NFC device was a credit card. This may include an email address, text message, or other unique identifier of the applicant's NFC enabled device 34, or even other NFC devices 34 at credit instrument dispensing locations 20 that may be provided to the applicant for temporary use, or to purchase. The Credit Instrument enabling credentials and material is then transmitted to applicant 28 or other recipient (such as NFC device 34), and the Credit Instrument enabling material is obtained at 514 by accessing the Credit Instrument Producers server 18 downloading the required material into the NFC enabled device. Method 500 may then continue to 224. Essentially, the same credit card parameters and credentials that may be sent to the credit instrument dispenser 22 by the credit instrument producer 18 may be made available through a secure link that can be accessed by the applicant's NFC enabled device 34. This allows the NFC enabled device 34 to transact with point of sale devices in the same manner as the credit card would.

It will be understood that any of the systems or entities that are part of system 10 may have one or more computing devices, such as servers, mobile devices, personal computers and the like, and required network technology, configured to allow the performance of the functionality described herein. Each of such systems or entities, and such computing devices, may have one or more computer-readable storage medium, that may be transitory or non-transitory, that may contain a set of programming instructions that may be executed by the computing devices.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

1. A method for dispensing a credit instrument to an applicant at an onsite or remote location, by a credit instrument issuer, responsive to a credit instrument application, the method comprising:
creating a credit instrument application using an application creation computing device to electronically obtain application data from an applicant;
sending the credit instrument application to a data collection server;
receiving by the data collection server, a credit instrument application decision from a credit decisioner;
if the credit instrument application decision is an approve:
receiving one or more credit instrument parameters from a credit instrument issuer;
dispensing a credit instrument for the applicant with the credit instrument parameters.

2. The method of claim 1 wherein the creating further comprises:
scanning, by the application creation computing device, an identification instrument of the applicant;
populating one or more application fields of a credit instrument application, based on said scanning.

3. (canceled)

4. The method of claim 2 wherein the creating further comprises confirming the identification of the applicant.

5. The method of claim 4 wherein the confirming further comprises:
obtaining a picture of the applicant;
comparing the picture of the applicant to the scanning of the identification instrument to determine if it is the same person; and
if the picture and the identification instrument are of the applicant:
creating the credit instrument application.

6. (canceled)

7. The method of claim 5 wherein the comparing is performed by facial recognition software.

8. The method of claim 4 wherein the confirming comprises validating the consumer's identity information against an identity database.

9. (canceled)

10. The method of claim 1 wherein the receiving further comprises:
authenticating the application creation computing device and user thereof;
acknowledging the receiving to the application creation computing device; and
deleting the credit instrument application at the application creation computing device.

11. The method of claim 1 wherein the credit instrument is a credit card and the dispensing comprises printing a credit card with the credit instrument parameters.

12. The method of claim 1 wherein the credit instrument is near field communication (NFC) on an applicant's mobile device and the dispensing comprises:
directing one or more of near-field communication enabling material and credit instrument parameters to an applicant's mobile device, wherein such near-field communication enabling material is configured to be installed and run on the applicant's mobile device and provide NFC capability in combination with the credit instrument parameters.

13. The method of claim 1 wherein the notifying comprises sending a notification to the application creation computing device, within five minutes of the receiving.

14. The method of claim 13 wherein the dispensing occurs within five minutes of the receiving.

15. The method of claim 11 wherein the creating and the dispensing occur at a credit instrument issuer location.

16. The method of claim 15 wherein the credit instrument issuer location is a retail store.

17. (canceled)

18. (canceled)

19. A method for submitting a credit instrument application on behalf of an applicant via an application creation computing device, the credit instrument application comprising a set of required credit instrument application fields, the method comprising:
scanning an identification provided by the applicant;
populating one or more required credit instrument application fields of the set of required credit instrument application fields;
confirming the applicant's identity; and
if confirmed:
submitting the credit instrument application.

20. The method of claim 19 wherein if the result of the obtaining is less than the set of required credit instrument application fields:
entering a further one or more required credit instrument application fields to obtain the set of required credit instrument application fields.

21. The method of claim 20 wherein the confirming further comprises:
obtaining a picture of the applicant;
comparing the picture of the applicant to the scanning of the identification instrument to confirm if it is the same person.

22. (canceled)

23. The method of claim 21 wherein the comparing is performed by facial recognition software.

24. The method of claim 19 wherein the confirming comprises multi-modal authentication.

25. The method of claim 19 wherein the confirming comprises validating the consumer's identity information against an identity database.

26. (canceled)

27. (canceled)

28. (canceled)

29. (canceled)

30. (canceled)

31. A system for dispensing a credit instrument to an applicant at an onsite or remote location, by a credit instrument issuer, responsive to a credit instrument application, the system comprising:
an application creation computing device, configured to:
electronically obtain application data from an applicant;
create a credit instrument application on behalf of an applicant;
send the credit instrument application to a data collection server; and
receive a credit instrument application decision;
a data collection server, configured to:
receive the credit instrument application;
obtain a credit instrument application decision from a credit decisioner;
notify the application creation computing device of the credit instrument application decision;
if the credit instrument application decision is an approve:
receive one or more credit instrument parameters from a credit instrument issuer; and
provide the credit instrument parameters to a credit instrument dispenser; and
a credit instrument dispenser configured to:
receive one or more credit instrument parameters from the data collection server; and
dispense a credit instrument for an applicant including the credit instrument parameters.

32. (canceled)

33. (canceled)
